(19) United States
(12) Patent Application Publication
(10) Pub. No.: US 2023/0391208 A1
(43) Pub. Date: Dec. 7, 2023

(54) Inverter Device For An Electric Vehicle, Drive Device And Method For Providing A Drive Voltage For A Drive Motor For An Electric Vehicle

(71) Applicant: ZF Friedrichshafen AG, Friedrichshafen (DE)

(72) Inventors: Frank SEEMANN, Euerbach (DE); Andre EHRSAM, Bergrheinfeld (DE); Martin MACH, Pizen 3 (CZ); Zbynek STEPAN, Pizen3 (CZ); Vladimir DVORAK, schwandorf (DE); Gabriel SCHERER, Deggenhausertal (DE); Rico GLOCKNER, Pocking (DE)

(73) Assignee: ZF Friedrichshafen AG, Friedrichshafen (DE)

(21) Appl. No.: 18/032,952

(22) PCT Filed: Oct. 18, 2021
(86) PCT No.: PCT/EP2021/078752

§ 371 Date: Apr. 20, 2023

(30) Foreign Application Priority Data
Oct. 22, 2020 (DE) 10 2020 213 313.1

(51) Int. Cl. B60L 50/51; B60L 1/00; B60L 50/60; H02P 27/06; H02M 7/537

(52) U.S. Cl. CPC B60L 50/51; B60L 1/003; B60L 50/60; B60L 1/20; H02P 27/06; H02M 7/537; B60L 2210/42; B60L 2210/30

(57) ABSTRACT

An inverter device for providing a drive voltage for a drive motor (110) for an electric vehicle (100). The inverter device (108) has a battery interface (130) for connecting the inverter device (108) to a vehicle battery (104) of the electric vehicle (100), a drive interface (116) for connecting the inverter device (108) to the drive motor (110), and an auxiliary interface (118) for connecting the inverter device (108) to an auxiliary drive (112). The inverter device (108) further has an inverter (140) to convert a DC voltage applied to the battery interface (130) into an AC voltage and to provide the latter either at the drive interface (116) or at the auxiliary interface (118) using a control signal (132).

### PRIORITY CLAIM

This is a U.S. national stage of application No. PCT/EP2021/078752 filed on Oct. 18, 2021. Priority is claimed on German Application No. 10 2020 213 313.1, filed Oct. 22, 2020, the content of which is incorporated here by reference.

### BACKGROUND OF THE INVENTION

The present invention is directed to an inverter device for providing a drive voltage for a drive motor for an electric vehicle, to a drive device and to a method for providing a drive voltage for a drive motor for an electric vehicle.

Electrified vehicles are becoming increasingly important industrially for their environmental friendliness. The goal is for not only passenger vehicles but also utility vehicles to be driven electrically.

### SUMMARY

The present invention provides an improved inverter device for providing a drive voltage for a drive motor for an electric vehicle, an improved drive device and an improved method for providing a drive voltage for a drive motor for an electric vehicle according to the main claims. Advantageous embodiments will be apparent from the subclaims and the following description.

The approach suggested herein provides a possibility of lowering costs in a production of an electrified vehicle, advantageously a utility vehicle. This can be achieved by means of an inverter which is suitable for converting a battery voltage into an AC voltage for operating a drive motor of the vehicle and into an AC voltage for operating an auxiliary motor. This obviates the need for two separate inverters, one for operating the drive motor and one for operating the auxiliary motor.

An inverter device is disclosed for providing a drive voltage for a drive motor for an electric vehicle. The inverter device has a battery interface for connecting the inverter device to a vehicle battery of the electric vehicle, a drive interface for connecting the inverter device to the drive motor, and an auxiliary interface for connecting the inverter device to an auxiliary drive. The inverter device further has an inverter which is formed to convert a DC voltage applied to the battery interface into an AC voltage and to provide the latter either at the drive interface or at the auxiliary interface using a control signal.

The inverter device can be part of an electric vehicle or installed in an electric vehicle, for example. The electric vehicle can be implemented, for example, as an electrified utility vehicle. A utility vehicle may be, for example, an excavator or a truck having, e.g., a crane suspension. The drive motor can be formed to set the electric vehicle in motion, for example, to enable forward travel or reverse travel. The auxiliary drives can be formed to provide a functionality or motion over and above locomotion. For example, the auxiliary drive can be used to drive an excavator bucket or a crane of the electric vehicle. To this end, the inverter device is advantageously multifunctional. The control signal can be provided, for example, by an operator control unit of the electric vehicle or a control device. The control signal can be suitable for adjusting at least one parameter of the AC voltage, for example, a frequency or amplitude. Additionally or alternatively, the control signal can be suitable for controlling a supplying of AC voltage to the drive interface and/or the auxiliary interface.

According to an embodiment form, the inverter can be formed to provide the AC voltage at the drive interface when the control signal represents a drive function of the electric vehicle. The inverter can further be formed to provide the AC voltage at the auxiliary interface when the control signal represents an auxiliary function of the electric vehicle. To this end, the inverter can comprise a suitable switching device in order to switch between the drive interface and the auxiliary interface. In addition, the inverter can advantageously be used as an interface, for example, to enable a charging function in addition to the drive function and auxiliary function and, additionally or alternatively, to enable an energizing function.

The inverter can be formed to provide the AC voltage at the auxiliary interface when the control signal represents a standstill of the electric vehicle. In this way, it can be ensured that sufficient power is available for operating the auxiliary motor.

According to an embodiment form, the inverter can be formed to convert an AC voltage applied to the auxiliary terminal into a DC voltage and to provide the latter at the battery interface in order to charge the vehicle battery. Accordingly, the auxiliary terminal can advantageously be used for feeding back energy or for connecting the inverter device to an external power supply.

According to an embodiment form, the inverter device can have a further inverter which is formed to convert a DC voltage applied to the battery interface into a further AC voltage and provide it at the auxiliary interface. Accordingly, the drive function can advantageously be carried out in parallel with the auxiliary function.

Also provided is a drive device which has an inverter device in one of the variants mentioned above. Further, the drive device has the drive motor for driving a wheel of the electric vehicle. The drive motor is connected to the drive interface. The drive device further has the auxiliary drive for providing an auxiliary function of the electric vehicle, this auxiliary drive being connected to the auxiliary interface.

The drive motor can be used to drive the wheel directly or, alternatively, via an axle of the electric vehicle. Depending on the drivetrain of the electric vehicle, the drive motor can also be used to drive a plurality of wheels of the electric vehicle.

According to an embodiment form, the drive device can have a further drive motor for driving a further wheel of the vehicle. The further drive motor can be connected to the drive interface or to a further drive interface of a further inverter.

According to an embodiment form, the auxiliary drive may be connected to a pump or may form a pump. The pump can be part of the electric vehicle or can be arranged separate from the electric vehicle. Additionally or alternatively, the auxiliary drive can be connected to a mechanical drive or can form a mechanical drive. The mechanical drive can be part of the electric vehicle or can be arranged separate from the electric vehicle. The pump can be implemented, for example, as a hydraulic pump. Accordingly, a multifunctionality is advantageously provided.

According to an embodiment form, the drive device can have a plug-in connector which is connected to the auxiliary interface. For example, extra-vehicular devices may be connected to the plug-in connector and energized. Additionally or alternatively, a charging current can be supplied via the plug-in connector for charging the vehicle battery.

Further, a method is suggested for providing a drive voltage for a drive motor for an electric vehicle using an inverter device. The method comprises a step of converting a DC voltage applied to the first terminal of the inverter into an AC voltage and a step of providing the AC voltage either to the drive interface or to the auxiliary interface of the inverter using the control signal.

Accordingly, the electric vehicle can advantageously execute a plurality of functions by means of the inverter device in parallel or consecutively.

According to an embodiment form, the method can comprise a step of determining the control signal depending on an operating function of the electric vehicle. A driver or operator of the electric vehicle can advantageously request a vehicle function to be executed, for example, via an operator control unit. The operator control unit can be formed to provide the control signal corresponding to the vehicle function to be executed.

### BRIEF DESCRIPTION OF THE DRAWINGS

The invention will be described in more detail by way of example referring to the accompanying drawings. The drawings show:

FIG. 1 a schematic depiction of an electric vehicle with a drive device according to an embodiment example; and

FIG. 2 a flowchart depicting a method for providing a drive voltage for a drive motor for an electric vehicle according to an embodiment example.

### DETAILED DESCRIPTION OF THE PRESENTLY PREFERRED EMBODIMENTS

In the following description of preferred embodiment examples of the present invention, comparable elements depicted in the various figures are provided with identical or like reference numerals so as to avoid repetitive description of these elements.

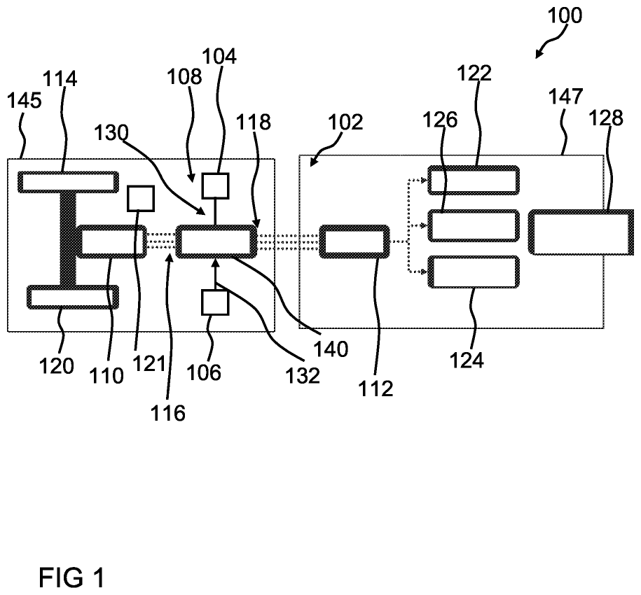

FIG. 1 shows a schematic diagram of an electric vehicle 100 with a drive device 102 according to an embodiment example. The electric vehicle 100 is formed as a utility vehicle, for example, as a truck with a crane suspension.

According to an embodiment example, the electric vehicle 100 has a vehicle battery 104 and a control device 106 in addition to the drive device 102. Alternatively, the vehicle battery 104 and/or the control device 106 can be considered as part of the drive device 102. The vehicle battery 104 is formed to energize the electric vehicle 100 so that vehicle functions can be carried out. The control device 106 is formed to control an operation of the drive device 102, for example, to control or implement a method for providing a drive voltage as will be described more fully referring to the following figures.

According to this embodiment example, the drive device 102 has an inverter device 108, a drive motor 110 and an auxiliary drive 112. The drive motor 110 and the auxiliary drive 112 are implemented, for example, as electric motors. The drive motor 110 is formed to drive at least one wheel 114 of the electric vehicle 100 and is connected to a drive interface 116 of the inverter device 108. The drive motor 110 is coupled directly to the wheel 114 or to a wheel axle of the electric vehicle 100, for example. Accordingly, the drive motor 110 can be used for locomotion of the electric vehicle 100. The auxiliary drive 112 is formed to provide an auxiliary function of the electric vehicle 100. To this end, the auxiliary drive 106 is connected to an auxiliary interface 118 of the inverter device 108. The auxiliary drive 106 can be used, for example, to drive a machine or a device. In particular, the auxiliary drive according to an embodiment example is not provided for the locomotion of the electric vehicle 100. According to an embodiment example, it is merely optional that the drive device 102 has a further drive motor for driving a further wheel 120 of the electric vehicle 100. For this purpose, the further drive motor is connected to the drive interface 116 or to a further drive interface of a further inverter 121. The drive motor 110 and the further drive motor are formed or can be formed similarly, for example. Accordingly, using the inverter device 108, a plurality of drive motors can also be supplied with an operating voltage required for the operation of the drive motors.

According to an embodiment example, the auxiliary drive 112 is connected to a pump 122 or to a mechanical drive 124 or is formed as a pump 122 or mechanical drive 124. Also optionally, the auxiliary interface 118 according to this embodiment example is coupled with an electric interface 126, for example, a plug-in connector 128. For example, the plug-in connector 128 is formed as a plug socket. Extra-vehicular devices, for example, can be connected via the electric interface 126. The electric interface 126 can also be used for charging or feeding in energy so that, for example, a charging process of the vehicle battery 104 and/or an energization process of the extra-vehicular device can be carried out.

The inverter device 108 is formed to provide a drive voltage for the drive motor 110. The inverter device 108 has a battery interface 130 for connecting the inverter device 108 to the vehicle battery 104, the drive interface 116 for connecting the inverter device 108 to the drive motor 110, and the auxiliary interface 118 for connecting the inverter device 108 to the auxiliary drive 112. The inverter device 108 further has an inverter 140 which is formed to convert a DC voltage into an AC voltage. The DC voltage is provided by the vehicle battery 104 at the battery interface 130. The inverter 140 is formed to provide the AC voltage either at the drive interface 116 or at the auxiliary interface 118 using a control signal 132. The control signal 132 can be determined, for example, by a user of the electric vehicle 100 by means of an operator control unit of the electric vehicle 100.

According to an embodiment example, the inverter 140 provides the AC voltage at the drive interface 116 when the control signal 132 represents a drive function of the electric vehicle 100. Further, according to an embodiment example, the inverter 140 provides the AC voltage at the auxiliary interface 118 when the control signal 132 represents an auxiliary function of the electric vehicle 100, that is, when, for example, the pump 122, the mechanical drive 124 or the plug-in connector 128 is actuated.

Further, according to an embodiment example, the inverter 140 is optionally formed to convert an AC voltage applied, for example, to the auxiliary interface 118 into a DC voltage and to provide the latter at the battery interface 130. The vehicle battery 104, for example, is charged in this way. This means that the inverter according to this embodiment example is formed to convert applied voltages bidirectionally.

According to an embodiment example, the inverter 140 is formed to provide the AC voltage so as to be controlled by the control signal 132 either at the drive interface 116 or at the auxiliary interface 118 and, on the other hand, to adapt a parameter of the AC voltage. For example, the inverter 140 is formed to adjust a parameter of the AC voltage to a first value when the AC voltage is provided at the drive interface 116 and to adjust the parameter to a second value when the AC voltage is provided at the auxiliary interface 118. The parameter relates to a frequency or amplitude of the AC voltage, for example. In this way, an AC voltage which is suitable either for operation of the drive motor 110 or for operation of the auxiliary motor 112 is generated and provided using the DC voltage of the vehicle battery 104 applied to the battery interface 130.

According to an embodiment example, the inverter 140 has a transistor bridge circuit which is used both for generating the AC voltage which can be provided at the drive interface 116 and for generating the AC voltage which can be provided at the auxiliary interface 118.

According to an embodiment example which is merely optional, the inverter device 108 has the further inverter 121 which is formed to convert a DC voltage applied to the battery interface 130 into a further AC voltage and to provide the latter at a further drive motor or at the auxiliary interface 118. This means that the further inverter 121 merely offers the same function or the same functions as inverter 140 or additional functions.

According to an embodiment example, the vehicle 100 comprises a towing vehicle 145 and a trailer 147. The auxiliary drive 112 is arranged at the trailer 147 but can also be arranged in a corresponding manner at the towing vehicle 145 or external to the electric vehicle 100.

Accordingly, it is also possible to use the inverter device 108, also known as a power drive inverter, for a plurality of functions, generally, for example, for trucks, construction machines or work machines. Since the inverter device 108 makes up most of the cost for an electric power drive, the approach described herein suggests a possibility to save costs. The inverter device 108 according to this embodiment example is formed to control a plurality of drives, designated herein as drive motor 110 and auxiliary drive 112. These motors are controllable independent from one another, for example. The approach suggested herein further allows the inverter device 108 to be used as an electric interface, for example, for charging the vehicle battery 104 or feeding into a power supply. To this end, the inverter device 108 enables not only the drive function but also the auxiliary function and/or is usable, for example, as an auxiliary unit. For example, once the electric vehicle 100 is at a standstill, the inverter device 108 according to an embodiment example is usable for the auxiliary drive 112 which, for example, is connected to the pump 122 or provides a pump functionality. According to an embodiment example, a power drive of the electric vehicle 100 can be implemented, for example, as an axle drive, individual wheel drive or all-wheel drive. A drive in which, for example, two motors are arranged at one axle, can also be implemented. Alternatively, the electric vehicle 100 is also implemented, for example, as an agricultural machine or as a construction machine with a drivetrain having an electric motor, for example, a hybrid, eCVT, serial hybrid, EV, BEV, FCEV, which operate a stationary application while standing.

In an alternative embodiment example, the electric vehicle 100 remains in motion during the auxiliary function. This is possible, for example, when the electric vehicle 100 has an axle drive with two integrated drive motors. In this regard, it is conceivable that the further inverter 121 provides the drive motor 110 or the further drive motor for the driving operation with a required operating voltage and the inverter 140 provides the auxiliary drive 112 with a required operating voltage in order, for example, to control a vehicle body of the electric vehicle 100 at low speeds.

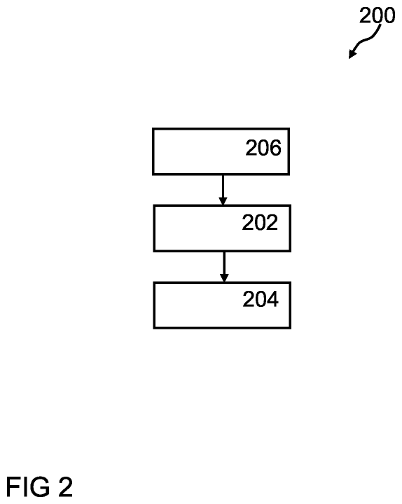

FIG. 2 shows a flowchart for a method 200 for providing a drive voltage for a drive motor for an electric vehicle according to an embodiment example. The method 200 is applicable, for example, in an electric vehicle with the drive motor as was described referring to FIG. 1. By means of the method 200, the drive voltage for the drive motor is provided using an inverter device as was likewise described in FIG. 1. To this end, the method 200 comprises a step 202 of converting a DC voltage applied to the first terminal of the inverter into an AC voltage and a step 204 of providing the AC voltage either as the drive voltage at the drive interface or as an auxiliary voltage at the auxiliary interface of the inverter using the control signal. Merely optionally, the method 200 further comprises a step 206 of determining the control signal depending on an operating function of the electric vehicle. According to this embodiment example, the step 206 of determining is carried out prior to the step 202 of converting. Steps 202, 204, 206 can be carried out repeatedly in succession in order, for example, to be able to realize change requests of a user of the electric vehicle with respect to the operating function.

1. Inverter device (108) for providing a drive voltage for a drive motor (110) for an electric vehicle (100), wherein the inverter device (108) has the following features: a battery interface (130) for connecting the inverter device (108) to a vehicle battery (104) of the electric vehicle (100), a drive interface (116) for connecting the inverter device (108) to the drive motor (110), an auxiliary interface (118) for connecting the inverter device (108) to an auxiliary drive (112), and an inverter (140) which is formed to convert a DC voltage applied to the battery interface (130) into an AC voltage and to provide the latter either at the drive interface (116) or at the auxiliary interface (118) using a control signal (132).

2. Inverter device (108) according to claim 1, wherein the inverter (140) is formed to provide the AC voltage at the drive interface (116) when the control signal (132) represents a drive function of the electric vehicle (100), and wherein the inverter (140) is formed to provide the AC voltage at the auxiliary interface (118) when the control signal (132) represents an auxiliary function of the electric vehicle (100).

3. Inverter device (108) according to one of the preceding claims, wherein the inverter (140) is formed to provide the AC voltage at the auxiliary interface (118) when the control signal (132) represents a standstill of the electric vehicle (100).

4. Inverter device (108) according to one of the preceding claims, wherein the inverter (140) is formed to convert an AC voltage applied to the auxiliary interface (118) into a DC voltage and to provide the latter at the battery interface (130) in order to charge the vehicle battery (104). Inverter device (108) according to one of the preceding claims, with a further inverter (140) which is formed to convert a DC voltage applied to the battery interface (130) into a further AC voltage and provide it at the auxiliary interface (118).

6. Drive device (102) for an electric vehicle (100), wherein the drive device (102) has the following features: an inverter device (108) according to one of the preceding claims, the drive motor (110) for driving a wheel (114) of the electric vehicle (100), wherein the drive motor (110) is connected to the drive interface (116), and the auxiliary drive (112) for providing an auxiliary function of the electric vehicle (100), wherein the auxiliary drive (112) is connected to the auxiliary interface (118).

7. Drive device (102) according to claim 6, with a further drive motor for driving a further wheel (120) of the electric vehicle (100), wherein the further drive motor is connected to the drive interface (116) or to a further drive interface of a further inverter (140).

8. Drive device (102) according to one of claim 6 or 7, wherein the auxiliary drive (112) is connected to a pump (122) or a mechanical drive (124) of the electric vehicle (100).

9. Drive device (102) according to one of claims 6 to 8, with a plug-in connector (128) which is connected to the auxiliary interface (118). Method (200) for providing a drive voltage for a drive motor (110) for an electric vehicle (100) using an inverter device (108) according to one of claims 1 to 5, wherein the method (200) comprises the following steps: converting (202) a DC voltage applied to the battery interface (130) into the AC voltage; and providing (204) the AC voltage either at the drive interface (116) or at the auxiliary interface (118) of the inverter (140) using the control signal (132).

11. Method (200) according to claim 10, with a step (206) of determining the control signal (132) depending on an operating function of the electric vehicle (100).
